(19) United States
(12) Patent Application Publication
(10) Pub. No.: US 2013/0026837 A1
(43) Pub. Date: Jan. 31, 2013

(54) POWER SUPPLY DEVICE, METHOD OF CONTROLLING POWER SUPPLY DEVICE, AND IMAGE FORMING APPARATUS

(71) Applicant: Takumi NOZAWA, Kanagawa (JP)

(72) Inventor: Takumi NOZAWA, Kanagawa (JP)

(21) Appl. No.: 13/552,990

(22) Filed: Jul. 19, 2012

(30) Foreign Application Priority Data
Jul. 25, 2011 (JP) 2011-162425

(51) Int. Cl. H02J 4/00; H02J 7/00

(52) U.S. Cl. 307/66; 320/107

(57) ABSTRACT

A power supply device includes a power generation unit; a plurality of storage batteries configured to be charged with power output from the power generation unit; a monitoring unit configured to monitor a state of each storage battery and the power output from the power generation unit; and a control unit configured to select one of the storage batteries to supply power to a target device on the basis of a monitoring result by the monitoring unit when the target device is in a power saving mode, the control unit being configured to control charging of each storage battery.

### CROSS-REFERENCE TO RELATED APPLICATION

The present application claims priority to and incorporates by reference the entire contents of Japanese Patent Application No. 2011-162425 filed in Japan on Jul. 25, 2011.

### BACKGROUND OF THE INVENTION

1. Field of the Invention

The present invention relates to a power supply device, a method of controlling a power supply device, and an image forming apparatus.

2. Description of the Related Art

Conventional devices, such as image forming apparatuses that have in-built functions such as scanning, plotting, and faxing, have been proposed and put into practical use in consideration of environmental problems and with regard to saving energy. Regarding such energy-saving apparatuses, a technology is already known in which power for the image forming apparatus when in the power-saving control mode is met by the power generation by a power generation device, such as a solar battery, and by the power generated by the power generation device and stored in a secondary battery, and thereby the power consumption in the power-saving control mode is reduced.

Japanese Patent No. 3416215 discloses a configuration in which the operation of a main power supply is stopped when in a power-saving control mode and power is supplied from a secondary battery (storage battery) or a solar battery. According to Japanese Patent No. 3416215, the power consumption in the power-saving control mode can be reduced.

However, the conventional technology has a disadvantage in that it is not always possible for power to be supplied from the secondary battery when in the power-saving control mode because the secondary battery has not been sufficiently charged due to the power generated by the power generating device being insufficient and due to a malfunction or spontaneous discharge of the secondary battery.

According to Japanese Patent No. 3416215, the main power supply is turned on if power cannot be supplied from the solar battery and the secondary battery due to insufficient power being generated by the solar battery or the second battery being discharged. However, this has a disadvantage in that the objective of power-saving cannot be accomplished.

Therefore, there is a need for a power supply device capable of preventing termination of the power supply by a storage battery when in a power-saving control mode.

### SUMMARY OF THE INVENTION

It is an object of the present invention to at least partially solve the problems in the conventional technology.

According to an embodiment, there is provided a power supply device that includes a power generation unit; a plurality of storage batteries configured to be charged with power output from the power generation unit; a monitoring unit configured to monitor a state of each storage battery and the power output from the power generation unit; and a control unit configured to select one of the storage batteries to supply power to a target device on the basis of a monitoring result by the monitoring unit when the target device is in a power saving mode, the control unit being configured to control charging of each storage battery.

According to another embodiment, there is provided a method of controlling a power supply device that includes monitoring, by a monitoring unit, states of a plurality of storage batteries and power output from a power generation unit; controlling, by a control unit, charging of each storage battery; and selecting, by the control unit, one of the storage batteries to supply power to a target device on the basis of a result at the monitoring when the target device is in a power saving mode.

According to another embodiment, there is provided an image forming apparatus that includes the power supply device according to the above embodiment; an image forming unit that is the target device; a main power supply unit configured to supply power to the image forming unit when the image forming unit is in at least a normal mode; and a power supply switch unit configured to switch a source of power supply to the image forming unit to the main power supply unit when the image forming unit is in the normal mode, and switch the source of power supply to at least one of the power generation unit and the storage batteries when the image forming unit is in the power saving mode.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an exemplary configuration of an image forming apparatus and an energy generation module that are applicable to a first embodiment of the present invention;

FIG. 2 is a sequence chart of the transition of the state of each unit according to the first embodiment of the present invention;

FIG. 3 is a sequence chart of the transition of the state of each unit according to the first embodiment of the present invention;

FIG. 4 is a sequence chart of the transition of the state of each unit according to the first embodiment of the present invention;

FIG. 5 is a block diagram of an exemplary configuration of an image forming apparatus and an energy generation module according to a first modification of the first embodiment of the present invention;

FIG. 6 is a block diagram of an exemplary configuration an image forming apparatus and an energy generation module according to a second modification of the first embodiment of the present invention;

FIG. 7 is a block diagram of an exemplary configuration an image forming apparatus and an energy generation module according to a third modification of the first embodiment of the present invention;

FIG. 8 is a block diagram of an exemplary configuration an image forming apparatus and an energy generation module according to a second embodiment of the present invention;

FIG. 9 is a schematic diagram of an exemplary configuration of a charge level determination table;

FIG. 10 is a schematic diagram of an exemplary screen indicating the charge level displayed on an operation unit;

FIG. 11 is a block diagram of an exemplary configuration of an image forming apparatus and an energy generation module according to a first modification of the second embodiment of the present invention;

FIG. 12 is a schematic diagram of an exemplary configuration of a life prediction table;

FIG. 13 is a schematic diagram of an exemplary screen indicating the predicted life of each battery unit displayed on the operation unit;

FIG. 14 is a block diagram of an exemplary configuration of an image forming apparatus and an energy generation module according to a second modification of the second embodiment of the present invention;

FIG. 15 is a schematic diagram of an exemplary screen indicating the value of the amount of generated power;

FIG. 16 is a schematic diagram of an exemplary configuration of a malfunction determination table; and

FIG. 17 is a sequence chart of the transition of the state of each unit, illustrating operations according to the third embodiment of the present invention.

### DETAILED DESCRIPTION OF THE PREFERRED EMBODIMENTS

Embodiments of a power supply device and an image forming apparatus according to the present invention will be described in detail below with reference to the accompanying drawings.

### First Embodiment

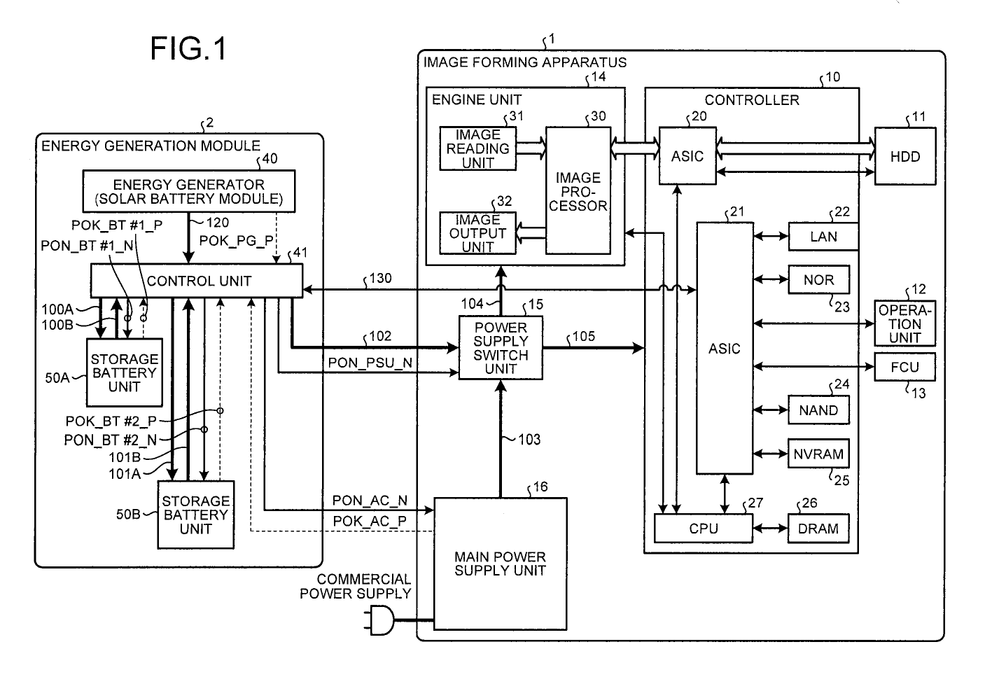

FIG. 1 shows an exemplary configuration of an image forming apparatus 1 and a power supply unit (energy generation module 2) that are applicable to a first embodiment of the present invention. The image forming apparatus 1 has a scanner function and a printer function and, by using a document image read by the scanner function, prints onto a paper sheet by using the printer function. The energy generation module 2 is used by connecting it to or incorporating it in the image forming apparatus 1. The energy generation module 2 supplies power to the image forming apparatus 1 when the operation mode of the image forming apparatus 1 is a sleep mode in which the power consumption is reduced compared to that of normal operation mode.

The configuration of the image forming apparatus 1 and the energy generation module 2 will be described in detail below using FIG. 1. The image forming apparatus 1 will be described first. The image forming apparatus 1 includes a controller 10, a hard disk drive (HDD) 11, an operation unit 12, a facsimile control unit (FCU) 13, an engine unit 14, a power supply switch unit 15, and a main power supply unit 16.

The main power supply unit 16 generates power to be used by each unit of the image forming apparatus 1 from, for example, a commercial power supply. Power 103 output from the main power supply unit 16 is supplied to the power supply switch unit 15. The power supply switch unit 15 switches between power 102 supplied from the energy generation module 2 and the power 103 supplied from the main power supply unit 16 and outputs the power. Power 104 and power 105 output from the power supply switch unit 15 are supplied to the engine unit 14 and the controller 10, respectively.

The power supply switch unit 15 can be configured to supply, for example, in a normal mode, the power 104 and the power 105 to the engine unit 14 and the controller 10, respectively and, in a sleep mode (power saving mode), to supply only the power 105 to the controller 10. Accordingly, less power is consumed in the sleep mode.

The engine unit 14 includes an image processor 30, an image reading unit 31, and an image output unit 32. The image reading unit 31 reads a document and outputs document image data. The image processor 30 performs predetermined image processing, such as processing, correction, editing, detection, and conversion, on the document image data output from the image reading unit 31. The image output unit 32 forms an image by using the image data output from the image processor 30. Specifically, the image output unit 32 prints onto a paper sheet on the basis of the image data.

The controller 10 includes an application specific integrated circuit (ASIC) 20, an ASIC 21, a local area network interface (LAN I/F) 22, and a central processing unit (CPU) 27 and further includes memories: a NOR flash memory 23, a NAND flash memory 24, a non-volatile random access memory (NVRAM) 25, and a dynamic RAM (DRAM) 26.

The HDD 11, the CPU 27, and the image processor 30 are connected to the ASIC 20 and the ASIC 20 controls data transfer between the HDD 11, the CPU 27, and the image processor 30. For example, the document image data output from the image reading unit 31 and on which the image processing is performed by the image processor 30 is compressed and coded by the ASIC 2 and then is temporarily stored in the HDD 11. When printing, the compression image data read from the HDD 11 is decompressed by the ASIC 20 and is then supplied to the image processor 30. The image processor 30 performs predetermined image processing on the image data supplied from the ASIC 20 and then supplies the image data to the image output unit 32.

The operation unit 12, the FCU 13, the LAN I/F 22, and the CPU 27 as well as the NOR flash memory 23, the NAND flash memory 24, and the NVRAM 25 are connected to the ASIC 21. The ASIC 21 controls data transfer between these connected units.

A program, such as firmware, is previously stored in the NOR flash memory 23. Predetermined tables, etc. are previously stored in the NAND flash memory 24. Setting vales regarding the image forming apparatus 1 are previously stored in the NVRAM 25. The CPU 27 controls whole operations of the image forming apparatus 1 by using the DRAM 26 as a work memory in accordance with, for example, the programs stored in the NOR flash memory 23.

The operation unit 12 includes operation keys for user operations, a display unit, and a driver circuit for driving the operation keys and the display unit. The operation unit 12 may be a touch panel having an integral configuration of operation keys and a display unit. The operation unit 12 outputs a control single in accordance with the operation. The control signal is supplied to the CPU 27 via the ASIC 21. The display unit gives a predetermined display on the basis of a display control signal that is generated by the CPU 27 according to the program supplied via the ASIC 21. The combination of the display on the display unit and the operation keys configures a graphical user interface (GUI) for the user to operate the image forming apparatus 1.

The FCU 13 implements the FAX function of the image forming apparatus 1. For example, the FCU 13 is connected to, for example, a public telephone line and performs FAX transmitting/receiving. The LAN I/F 22 controls data communications between the image forming apparatus 1 and an external information device, such as a personal computer.

The energy generation module 2 will be described below. The energy generation module 2 includes an energy generator 40, a control unit 41, a storage battery unit 50A, and a storage battery unit 50B. The energy generator 40 uses, for example, a solar battery module as a power generation device and generates power. Each of the storage battery units 50A and 50B includes a storage battery. For example, the storage battery unit 50A is charged using electricity that is input via a path 100A and outputs electricity that is discharged via a path 100B. Similarly, the storage battery unit 50B is charged using electricity that is input via a path 101A and outputs the electricity that is discharged via a path 101B.

The control unit 41 controls the connection of a path 120 for the power generated by the energy generator 40, the connection of the paths 100A and 100B for input and output of the storage battery unit 50A, and the connection of the paths 101A and 101B for input and output of the storage battery unit 50B. The control unit 41 further controls the charging and discharging of the storage battery units 50A and 50B. The control unit 41 further monitors the output of the power generated by the energy generator 40 and the state of the storage battery units 50A and 50B.

The control unit 41 controls the connections, charging and discharging. The control unit 41 also controls monitoring of each unit by using a signal POK_PG_P that is supplied from the energy generator 40 to the control unit 41, a signal PON_BT#1_N and a signal POK_BT#1_P communicated with the storage battery unit 50A, and a signal PON_BT#2_N and a signal POK_BT#2_P that are communicated with the storage battery unit 50B. The control unit 41 controls the main power supply unit 16 by using a signal PON_AC_N and a signal POK_AC_P.

The signal POK_PG_P indicates whether the energy generator 40 can supply power. The signal POK_PG_P at a logical high (H) level indicates that the power generated by the energy generator 40 is sufficient and thus power can be supplied. The signal POK_PG_P at a logical low (L) level indicates that the power generated by the energy generator 40 is insufficient and thus power cannot be supplied.

The signal PON_BT#1_N and the signal PON_BT#2_N are signals that are supplied from the control unit 41 to the storage battery units 50A and 50B and that control the storage battery units 50A and 50B such that they are in any one of a charge state, a discharge state, and a standby state. The signal POK_BT#1_P and the signal POK_BT#2_P are signals that are supplied from the storage battery unit 50A and the storage battery unit 50B to the control unit 41 and that indicate whether the storage battery units 50A and 50B can supply power. For example, the signal POK_BT#1_P at the H level indicates that the amount of charge in the storage battery unit 50A is sufficient and thus power can be supplied. The signal POK_BT#1_P at the L level indicates that the amount of charge in the storage battery unit 50A is insufficient and thus power cannot be supplied.

The signal PON_AC_N is a signal that is supplied from the control unit 41 to the main power supply unit 16 and that controls the on/off of the main power supply unit. The signal PON_AC_N at the L level turns on the main power supply unit 16 so that the power generated by the commercial power supply is output from the main power supply unit 16. The signal PON_AC_N at the H level turns off the main power supply unit 16 so that the power output from the main power supply unit 16 is stopped. The signal POK_AC_P is a signal that is supplied from the main power supply unit 16 to the control unit 41 and that indicates whether the main power supply unit 16 can supply power. The signal POK_AC_P at the L level indicates that the main power supply unit 16 can supply power. The signal POK_AC_P at the H level indicates that the main power supply unit 16 cannot supply power. For example, when the main switch of the image forming apparatus 1 is off, the main power supply unit 16 cannot supply power.

Furthermore, the control unit 41 transmits a signal PON_PSU_N to the power supply switch unit 15 to switch the source of the power supply to the image forming apparatus 1 between the main power supply unit 16 and the energy generation module 2. When the signal PON_PSU_N is at the H level, the power supplied from the energy generation module 2 is selected. When the signal PON_PSU_N is at the L level, the power supplied by the main power supply unit 16 is selected. Furthermore, the control unit 41 and the ASIC 21 in the controller 10 communicates, via a communication line 130, a state notification indicating whether the current state is the normal mode or the sleep mode.

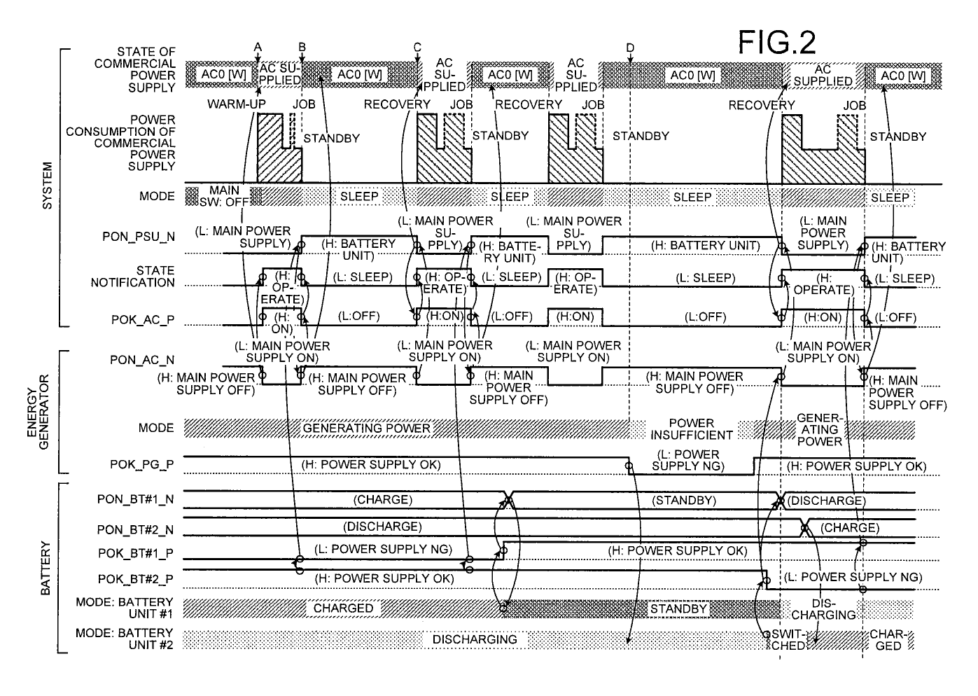

A power supply control method according to the first embodiment will be described, using FIGS. 2 to 4. FIG. 2 is a sequence chart of the transition of the state of each unit according to the first embodiment. FIGS. 2 to 4 show the storage battery unit 50A and the storage battery unit 50B as a storage battery unit #1 and a storage battery unit #2, respectively, for convenience.

Because the energy generation module 2 includes the storage battery units 50A and 50B and generates power at the energy generator 40, the energy generation module 2 can operate without any external power supply. If the signal POK_AC_P is at the L level and the main switch is off until the time point A, the signal POK_PG_P is at the H level and indicates that the energy generator 40 can supply power.

In this example, the energy generation module 2 includes the main switch. An operation output for the main switch is supplied to the control unit 41 and further transmitted to the ASIC 21 via the communication line 130.

In this example, initially, the signal POK_BT#1_P is at the L level and the signal POK_BT_#2 is at the H level and thus the storage battery unit 50A cannot supply power and the storage battery unit 50B can supply power. The storage battery unit 50A is controlled by the control unit 41 such that the storage battery unit 50A is charged using power generated by the energy generator 40. In addition, power can be supplied from the storage battery unit 50B to the control unit 41.

When the main switch is turned on at time point A, the control unit 41 causes the signal PON_AC_N to be at the L level to turn on the main power supply unit 16, thereby starting the power supply from the main power supply unit 16 to the power supply switch unit 15. The signal PON_PSU_N is at the L level in the initial state and the power supply from the main power supply unit 16 is selected. Thus, the power is supplied from the main power supply unit 16 to the engine unit 14 and the controller 10 via the power supply switch unit 15. The image forming apparatus 1 enters a standby state after the warm-up operations are completed, and then a job, etc. occur due to user operations.

If no further job occurs until a predetermined time elapses after the job is completed, the operation mode of the image forming apparatus 1 shifts from the normal mode to the sleep mode. At time pint B at which the operation mode shifts to the sleep mode, the signal POK_BT#1_P and the signal POK_BT#2_P are at the L level and the H level, respectively, which indicates that the storage battery unit 50B can supply power. Thus, the control unit 41 causes the signal PON_PSU_N to be at the H level, controls the power supply switch unit 15 so that it selects the power 102 from the control unit 41, and supplies the output of the storage battery unit 50B as the power 102 to the power supply switch unit 15. The control unit 41 causes the signal PON_AC_N to be at the H level to turn off the main power supply unit 16 and shifts the operation mode to the sleep mode.

When the operation mode recovers from the sleep mode (time point C), the control unit 41 causes the signal PON_AC_N to be at the L level to turn on the main power supply unit 16 and causes the signal PON_PSU_N to be at the L level to control the power supply switch unit 15 so that it selects the power 103 from the main power supply unit 16. Accordingly, the image forming apparatus 1 recovers to the normal mode and waits for a job.

In the energy generation module 2, in any of the normal mode and the sleep mode, if, for example, any one of the signal POK_BT#1_P and the signal POK_BT#2_P is at the L level and thus power cannot be supplied, the storage battery that cannot supply power is charged using power generated by the energy generator 40. In the example in FIG. 2, during the period from the time point A to the time point C, because the signal POK_BT#1_P is at the L level, the control unit 41 charges the storage battery unit 50A with power generated by the energy generator 40.

In the sleep mode, the power generated by the energy generator 40 may be insufficient. In the example in FIG. 2, the power generated by the energy generator 40 is insufficient at the time point D and the signal POK_PG_P transmitted from the energy generator 40 to the control unit 41 is changed from the H level to the L level. In contrast, because the storage battery unit 50B discharges at the time point D, no problem is caused to the power supply in the sleep mode.

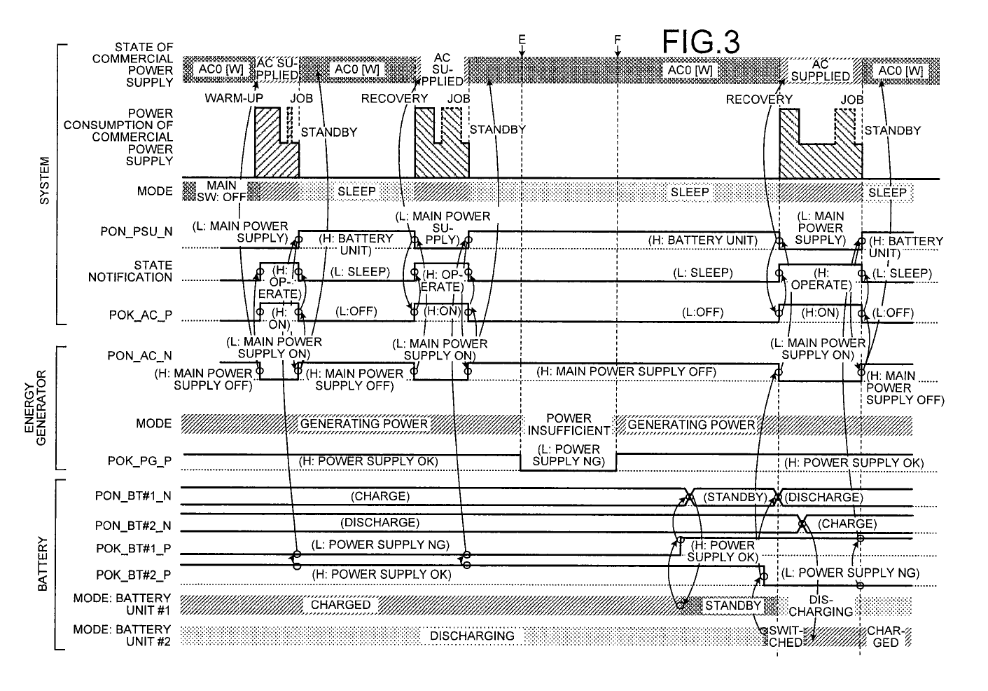

In the sleep mode, while the storage battery unit 50A and the storage battery unit 50B are being charged by using power generated by the energy generator 40, the power generated by the energy generator 40 may be insufficient. A case where the generated power becomes insufficient during charging will be described using FIG. 3, which is a sequence chart indicating the state transition of each unit. In the example in FIG. 3, the signal POK_BT#1_P is at the L level from when the main switch is initially off, which indicates that the storage battery unit 50A cannot supply power, and the signal PON_BT#1_N indicates “Charge”. Accordingly, the control unit 41 controls the storage battery unit 50A so that it is charged using power generated by the energy generator 40. When the amount of charge in the storage battery unit 50A is equal to or greater than a predetermined value, the signal POK-BT#1_P is changed from the L level to the H level and charging of the storage battery unit 50A ends.

It is assumed that the power generated by the energy generator 40 becomes insufficient at the time point E. When the amount of generated power is equal to or less than the predetermined value, the energy generator 40 changes the signal POK PG P transmitted to the control unit 41 from the H level to the L level to notify that power cannot be supplied. Thereafter, the generated power is recovered in the energy generator 40 and the signal POK_PG_P is changed from the L level to the H level to notify that power can be supplied (at the time point F). Because the power supply from the energy generator 40 stops while the storage battery unit 50A is being charged, the time until the amount of charge of the storage battery unit 50A becomes equal to or greater than the predetermined value is extended. In contrast, from the time point E to the time point F, the storage battery unit 50B discharges and supplying of the signal POK_BT#2_P at the H level to the control unit 41 is maintained. Thus, no problem occurs with the power supply in the sleep mode.

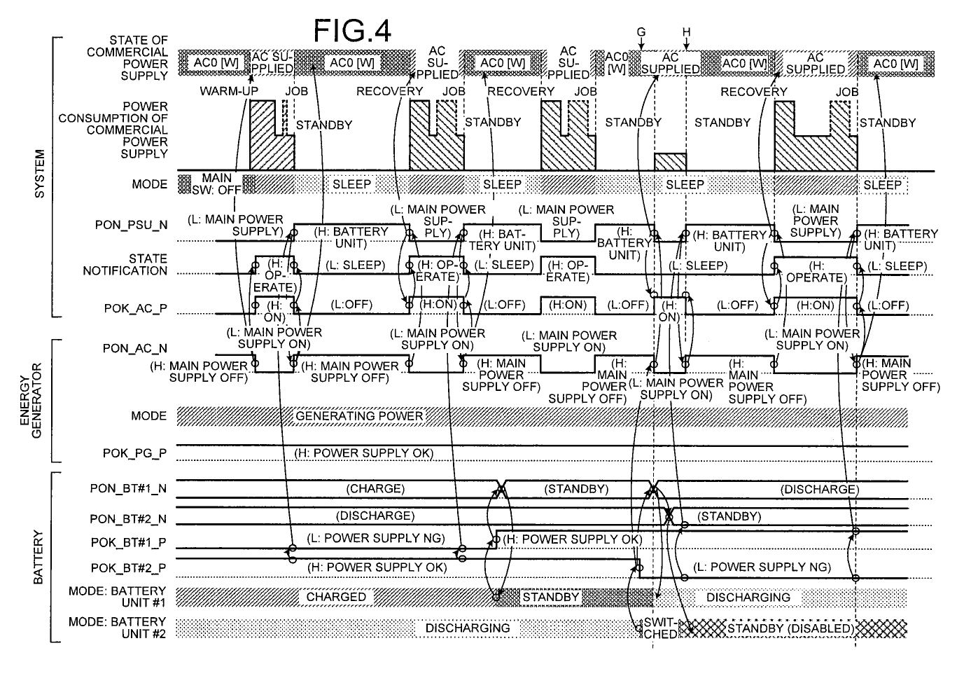

The storage battery unit 50A or the storage battery unit 50B may malfunction. A case where the storage battery unit 50B malfunctions while discharging in the sleep mode will be described using FIG. 4. In the example in FIG. 4, the storage battery unit 50B malfunctions at the time point G while discharging and thus cannot supply power. At the time point G, the storage battery unit 50A is sufficiently charged and thus in a standby state.

When the storage battery unit 50B detects its own malfunction at the time point G, the storage battery unit 50B changes the signal POK_BT_#2_P from the H level to the L level as notification that the storage battery unit 50B cannot supply power. In addition, the storage battery unit 50B changes to a switch state to switch to the standby (disabled) state due to the malfunction.

When the signal POK_BT#2_P from the storage battery unit 50B is changed to the L level, the control unit 41 changes the signal PON_BT#1_N from the state indicating “standby” to the state indicating “discharge” and switches the storage battery unit 50A to the discharge state. In addition, the control unit 41 changes the signal PON_BT#2_N to the state indicating “standby” and switches the storage battery unit 50B to the standby state. In the standby state, the storage battery unit 50B is disabled due to the malfunction.

There is a risk that a delay occurs when the storage battery units 50A and 50B are switched between the standby state and the discharge state and thus the power supply from the energy generation module 2 to the image forming apparatus 1 is terminated. Thus, power is supplied from the main power supply unit 16 in the period in which the delay occurs in order to prevent termination of the power supply to the image forming apparatus 1.

Specifically, when switching from the storage battery unit 50B to the storage battery unit 50A, the control unit 41 changes the signal PON_AC_N from the H level to the L level to turn on the main power supply unit 16. The control unit 41 then changes the signal PON_PSU_N from H level to L level to control the power supply switch unit 15 so that it selects the power 103 from the main power supply unit 16.

Here, the signal POK_BT#2_P is at the L level, which notifies the control unit 41 that the storage battery unit 50B cannot supply power. In contrast, the POK_BT#1_P is at the H level, which notifies the control unit 41 that the storage battery unit 50A can supply power. Thus, the control unit 41 changes the signal PON_PSU_N from the L level to the H level and controls the power supply switch unit 15 so that it selects the power 102 from the energy generation module 2. The control unit 41 changes the signal PON_AC_N from the L level to the H level to turn off the main power supply unit 16. At the time point H, where the main power supply unit 16 is turned off, the switching process ends.

As described above, the first embodiment includes the multiple storage battery units 50A and 50B and the control unit 41 that monitors the amount of charge in the storage battery units 50A and 50B and that controls charging and discharging. Accordingly, even if the storage battery units 50A and 50B are insufficiently charged due to power generated by the energy generator 40 being insufficient or even if any one of the storage battery units 50A and 50B malfunctions, the power supply from the energy generation module 2 to the image forming apparatus 1 in the sleep mode is prevented from being terminated. Accordingly, the reliability of the energy generation module 2 improves.

### First Modification of First Embodiment

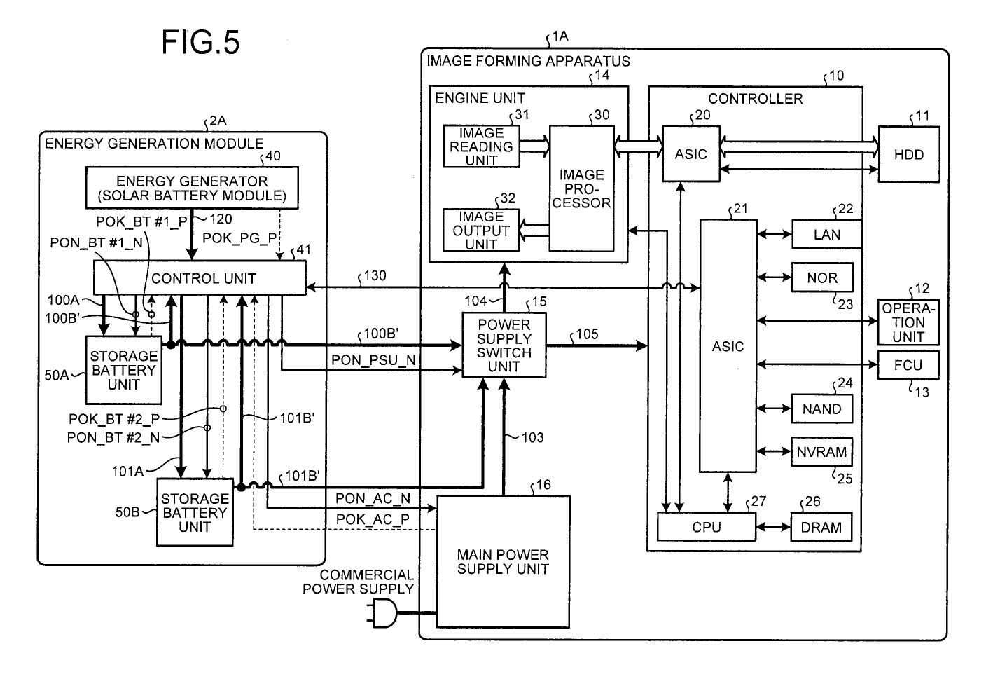

A first modification of the first embodiment will be described here. FIG. 5 shows an exemplary configuration of an image forming apparatus 1A and an energy generation module 2A of the first modification of the first embodiment. The components in FIG. 5 that are common to both FIG. 1 and FIG. 5 are denoted by the same reference numbers and detailed descriptions thereof are omitted.

As shown in FIG. 5, in the first modification of the first embodiment, in the energy generation module 2A, the outputs of the storage battery units 50A and 50B are supplied to the power supply switch unit 15 of the image forming apparatus 1A via paths 100B′ and 101B′. On the other hand, no power is supplied from the control unit 41 to the power supply switch unit 15. When the signal PON_PSU_N from the control unit 41 is at the H level, the power supply switch unit 15 selects the paths 100B′ and 101B′. The electricity output from any one of the storage battery units 50A and 50B for which the signal PON_BT#1_N and the signal PON_BT#2_N indicate the “discharge” state is supplied to each unit of the image forming apparatus 1A.

### Second Modification of First Embodiment

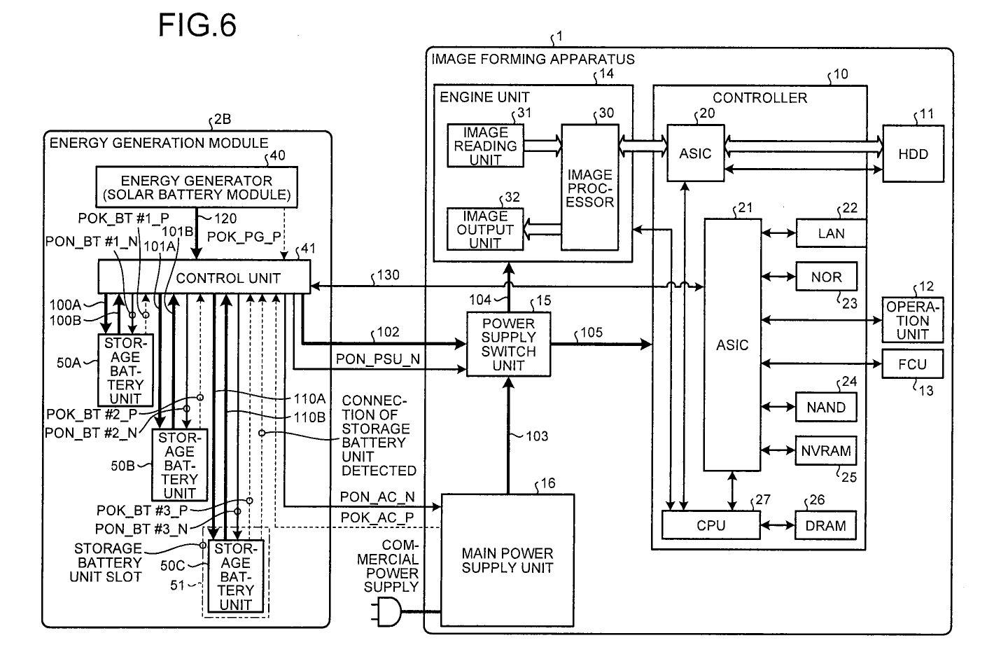

A second modification of the first embodiment will be described here. FIG. 6 shows an exemplary configuration of the image forming apparatus 1 and an energy generation module 2B of the second modification of the first embodiment. The components in FIG. 6 that are common to both FIG. 1 and FIG. 6 are denoted by the same reference numbers and detailed descriptions thereof are omitted.

As shown in FIG. 6, in the second modification of the first embodiment, the energy generation module 2B is provided with a storage battery unit slot 51 such that a storage battery unit 50C can be added to the storage battery units 50A and 50B. When the storage battery unit 50C is attached to the storage battery unit slot 51, the storage battery unit 50C and the control unit 41 are connected via various connection lines and thus signals are communicated therebetween.

More specifically, paths 110A and 110B for input to and output from the storage battery unit 50C are connected to the control unit 41. A signal PON_BT#3_N for controlling the storage battery unit 50C such that it is in any one of the discharge state, the charge state, and the standby state is transmitted from the control unit 41 to the storage battery unit 50C. Furthermore, a signal POK_BT#3_P indicating whether the storage battery unit 50C can supply power is transmitted from the storage battery unit 50C to the control unit 41.

Furthermore, a storage battery unit connection detection signal indicating that the storage battery unit 50C is connected is transmitted from the storage battery unit 50C to the control unit 41. The control unit 41 receives the storage battery unit connection detection signal and thus detects that the storage battery unit 50C is connected to the storage battery unit slot 51.

As described above, when the energy generation module 2B includes three storage battery units 50A, 50B, and 50C, it is assumed that, for example, the charging and discharging of the storage battery units 50A, 50B, and 50C are sequentially controlled by the respective storage battery units 50A, 50B, and 50C. The storage battery unit 50C can be used as a spare in case both of the storage battery units 50A and 50B malfunction.

In the second modification of the first embodiment, the added storage battery unit 50C can be controlled in a similar way to the storage battery units 50A and 50B and one of the discharge outputs from the storage battery units 50A, 50B, and 50C is selected and output from the control unit 41. Thus, the storage battery unit 50C can be added without changing the connecting specification between the energy generation module 2B and the image forming apparatus 1.

### Third Modification of First Embodiment

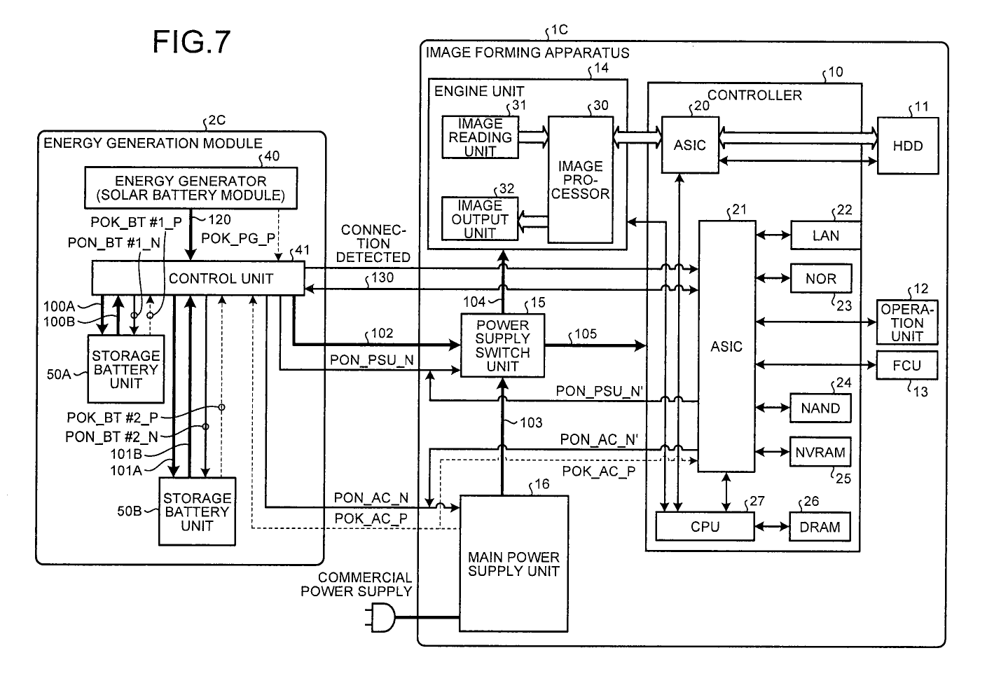

A third modification of the first embodiment will be described below. FIG. 7 shows an exemplary configuration of an image forming apparatus 1C and an energy generation module 2C according to the third modification of the first embodiment. The components in FIG. 7 that are common to both FIG. 1 and FIG. 7 are denoted by the same reference numbers and detailed descriptions thereof are omitted.

In the third modification of the first embodiment, a connection detection signal is transmitted from the control unit 41 to the ASIC 21 in the controller 10 of the image forming apparatus 1C. On the basis of the connection detection signal, the ASIC 21 determines whether the energy generation module 2C is connected to the image forming apparatus 1C. The ASIC 21 transmits a signal PON_PSU_N′ to the power supply switch unit 15 and transmits a signal PON_AC_N′ to the main power supply unit 16. The signal PON_PSU_N′ at the L level controls the power supply switch unit 15 so that it selects the power 103 supplied from the main power supply unit 16. The signal PON_AC_N′ is similar to the previously described signal PON_AC_N in that at the H level the signal PON_AC_N′ turns off the main power supply unit 16 and the signal PON_AC_N′ at the L level turns on the main power supply unit 16. Furthermore, the ASIC 21 receives the signal POK_AC_P that is transmitted from the main power supply unit 16.

When the ASIC 21 determines, on the basis of the connection detection signal, that the energy generation module 2C is connected, the ASIC 21 causes the signal PON_PSU_N′ and the signal PON_AC_N′ to be, for example, in a high impedance state to make the signals invalid. In contrast, when the ASIC 21 determines, on the basis of the connection detection signal, that the energy generation module 2C is not connected, the ASIC 21 causes the signal PON_PSU_N′ and the signal PON_AC_N′ to be at the L level. Such control allows the image forming apparatus 1C to operate using the power 103 from the main power supply unit 16 in a state in which the energy generation module 2C is not connected.

Accordingly, the energy generation module 2C can be connected only when required, and the energy generation module 2C can be configured as a unit independent of the image forming apparatus 1C.

### Second Embodiment

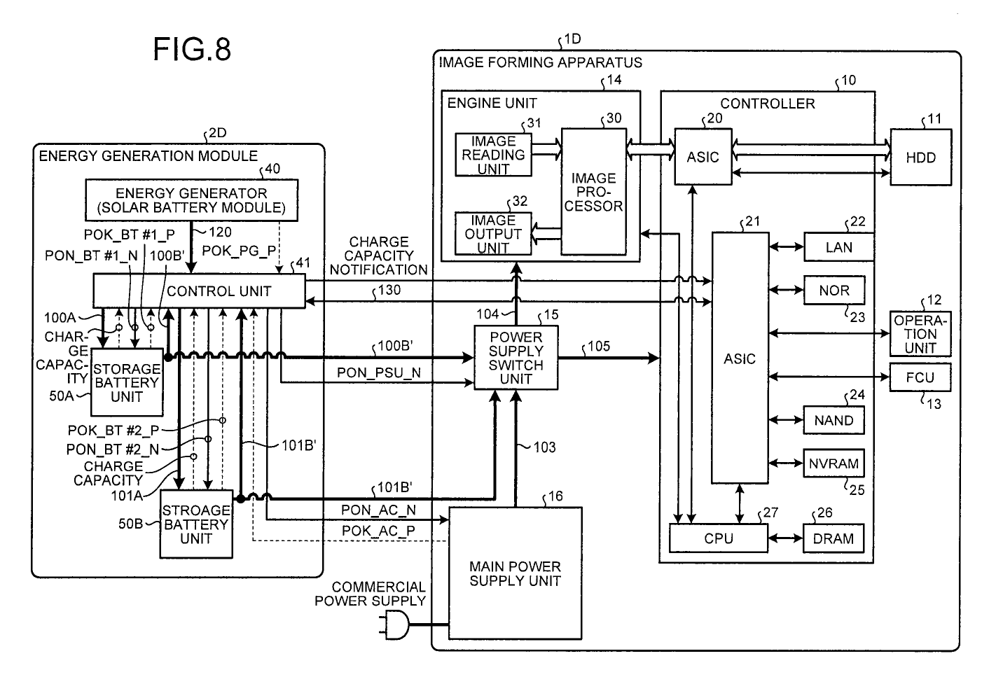

A second embodiment of the present invention will be described below. FIG. 8 shows an exemplary configuration of an image forming apparatus 1D and an energy generation module 2D according to the second embodiment. The components in FIG. 8 that are common to both FIG. 5 and FIG. 8 are denoted by the same reference numbers and detailed descriptions thereof are omitted. FIG. 8 shows a configuration that follows on from the previously described configuration in FIG. 5. However, the second embodiment is applicable to the configurations of the first embodiment and the modifications of the first embodiment.

In the second embodiment, in the energy generation module 2D, the storage battery units 50A and 50B transmit charge capacity notification signals indicating the charge capacities of the storage battery units 50A and 50B. For example, the storage battery units 50A and 50B measure the output voltages of their storage batteries and, on the basis of the result of the measurement, the amount of charge in the storage battery units 50A and 50B is obtained as charge capacities. On the basis of the signals indicating the charge capacities, which are signals transmitted from the storage battery units 50A and 50B, the control unit 41 transmits the charge capacity notification signals indicating the charge capacities of the storage battery units 50A and 50B to the ASIC 21 in the controller 10 of the image forming apparatus 1D.

A charge level determination table for determining the charge level on the basis of the charge capacity is previously stored in the NAND flash memory 24 in the controller 10. The charge level determination table further previously stores display information for a display corresponding to each charge level.

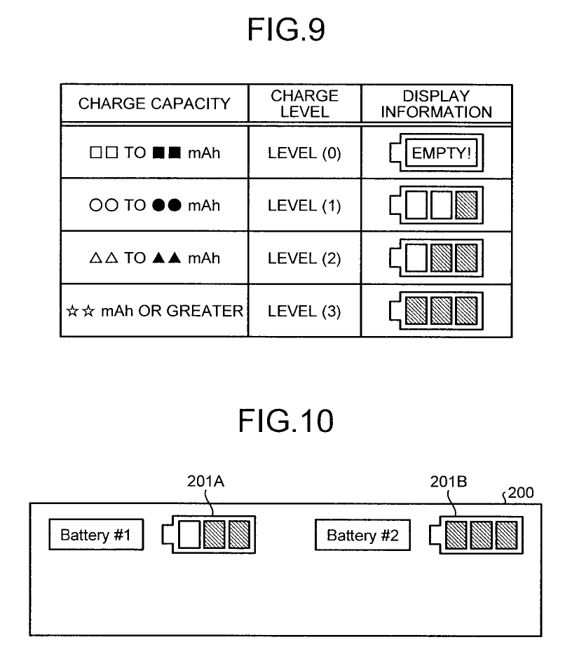

FIG. 9 shows an exemplary configuration of the charge level determination table. The charge capacity range and the charge level are associated with each other with respect to both of the storage battery units 50A and 50B and are stored in the charge level determination table. In the example in FIG. 9, charge levels from the level (0) to the level (3) are associated with four stages of charge capacity range.

In the charge level determination table, display information for displaying the charge level is associated with each charge level and stored. In this example, display information is stored in which “EMPTY” is displayed when the charge level is at the lowest level (0) and the number of filled blocks increases as the charge level increases in stages.

On the basis of the charge capacity notification signals received by the ASIC 21, the CPU 27 refers to the charge level determination table stored in the NAND flash memory 24 and determines the charge levels of the storage battery units 50A and 50B. The CPU 27 then generates a display control signal on the basis of display information associated with the charge levels obtained as a result of the determination and supplies the display control signal to the operation unit 12 via the ASIC 21. In accordance with the supplied display control signal, the operation unit 12 displays a screen indicating the charge levels on the display unit of the operation unit 12.

FIG. 10 shows an exemplary screen 200 indicating the charge levels displayed on the operation unit 12. In the example in FIG. 10, the charge levels of the respective storage battery units 50A and 50B are displayed as charge level displays 201A and 201B. The charge level displays 201A and 201B indicate that the charge levels of the storage battery units 50A and 50B are level (2) and level (3), respectively, and that the storage battery unit 50B is almost fully charged. As described above, according to the second embodiment, the user can see how much the storage battery units 50A and 50B are charged.

### First Modification of Second Embodiment

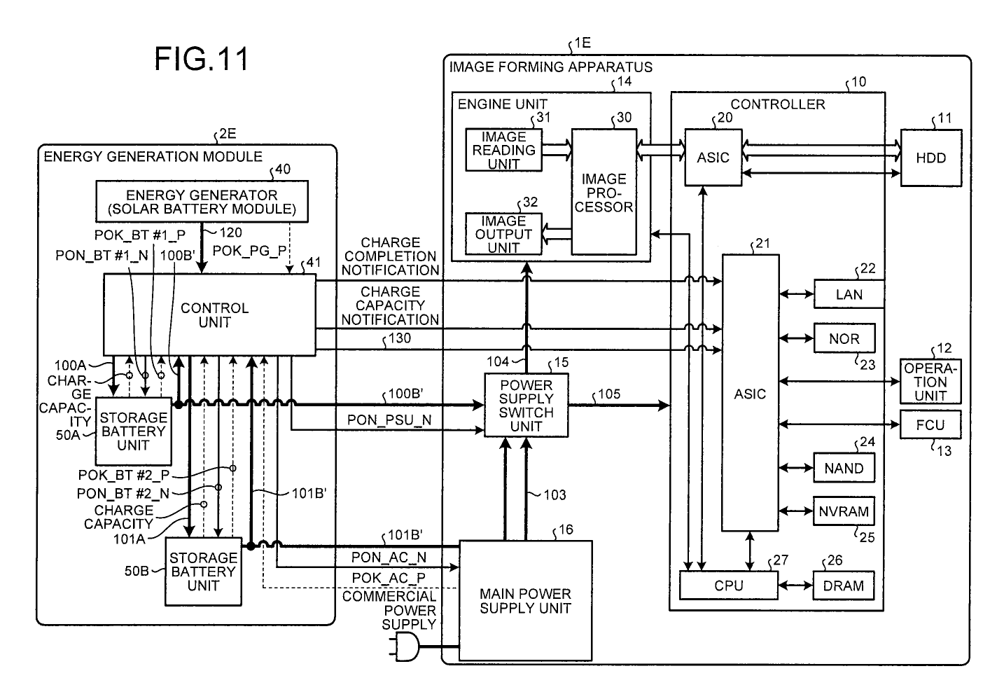

A first modification of the second embodiment will be described below. FIG. 11 shows an exemplary configuration of an image forming apparatus 1E and an energy generation module 2E according to the first modification of the second embodiment. The components in FIG. 11 that are common to both FIG. 5 and FIG. 11 are denoted by the same reference numbers and detailed descriptions thereof are omitted. In addition, FIG. 11 shows a configuration that follows on from the previously described configuration in FIG. 5. However, the first modification of the second embodiment is applicable to the configurations of the first embodiment, the modifications of the first embodiment, and the second embodiment.

In the first modification of the second embodiment, the storage battery units 50A and 50B respectively transmit charge capacity notification signals indicating the charge capacities to the control unit 41. The storage battery units 50A and 50B measure the output voltages of their storage batteries and, on the basis of the result of the measurement, the amount of charge in the storage battery units 50A and 50B is obtained as charge capacities. On the basis of the signals indicating the charge capacities, which are the signals transmitted from the storage battery units 50A and 50B, the control unit 41 determines that charging the storage battery units 50A and 50B is completed when the charge capacity is equal to or greater than a predetermined value and the control unit 41 then transmits a charge completion notification signal to the ASIC 21 in the controller 10.

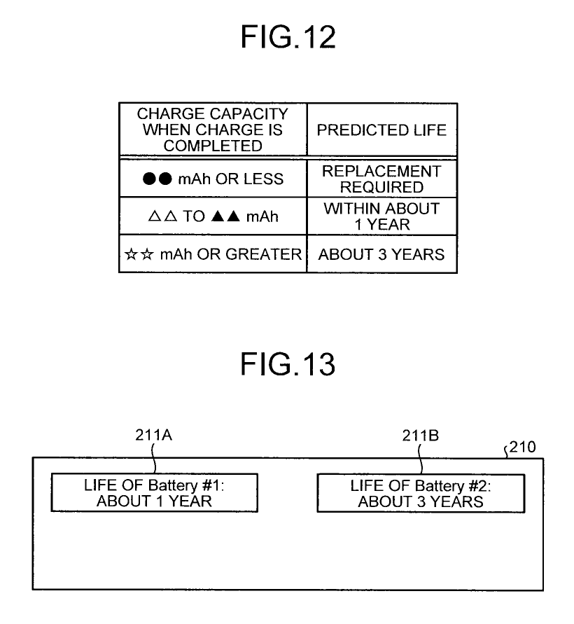

A life prediction table for predicting the lives of the storage battery units 50A and 50B on the basis of the charge capacities of the storage battery units 50A and 50B at the completion of the charge is previously stored in the NAND flash memory 24 of the controller 10. FIG. 12 shows an exemplary configuration of the life prediction table. The charge capacity range at the completion of the charging and the predicted level are associated with each other with respect to both of the storage battery units 50A and 50B and are stored in the life prediction table. In the example in FIG. 12, the predicted lives, such as ‘Replacement Required’, ‘Within Approximately 1 year’, and ‘Approximately 3 years’, are associated with the three stages of charge capacity range at charge completion.

On the basis of the charge capacity notification signals at the time when the ASIC 21 receives the charge completion notification signal, the CPU 27 refers to the life prediction table on the basis of the charge capacities of the storage battery units 50A and 50B at the completion of the charging and determines the lives of the storage battery units 50A and 50B. The CPU 27 generates a display control signal for displaying the predicted life obtained as a result of the determination and supplies the generated display control signal to the operation unit 12 via the ASIC 21. According to the supplied display control signal, the operation unit 12 displays a screen indicating the predicted lives on the display unit of the operation unit 12.

FIG. 13 shows an exemplary screen 210 of the predicted lives of the storage battery units 50A and 50B, which is the screen displayed on the operation unit 12. In the example in FIG. 13, the predicted lives of the respective storage battery units 50A and 50B are displayed as predicted life displays 211A and 211B. According to the predicted life displays 211A and 211B, the predicted lives of the storage battery units 50A and 50B are approximately 1 year and approximately three years, respectively. As described above, according to the first modification of the second embodiment, the user can easily see the predicted lives of the storage battery units 50A and 50B.

Furthermore, from the predicted lives of the storage battery units 50A and 50B displayed on the operation unit 12, it is possible to know the time when each of the storage battery units 50A and 50B should be replaced. Thus, the storage battery units 50A and 50B can be replaced before they become disabled, which prevents problems related to the lives of the storage battery units 50A and 50B.

### Second Modification of Second Embodiment

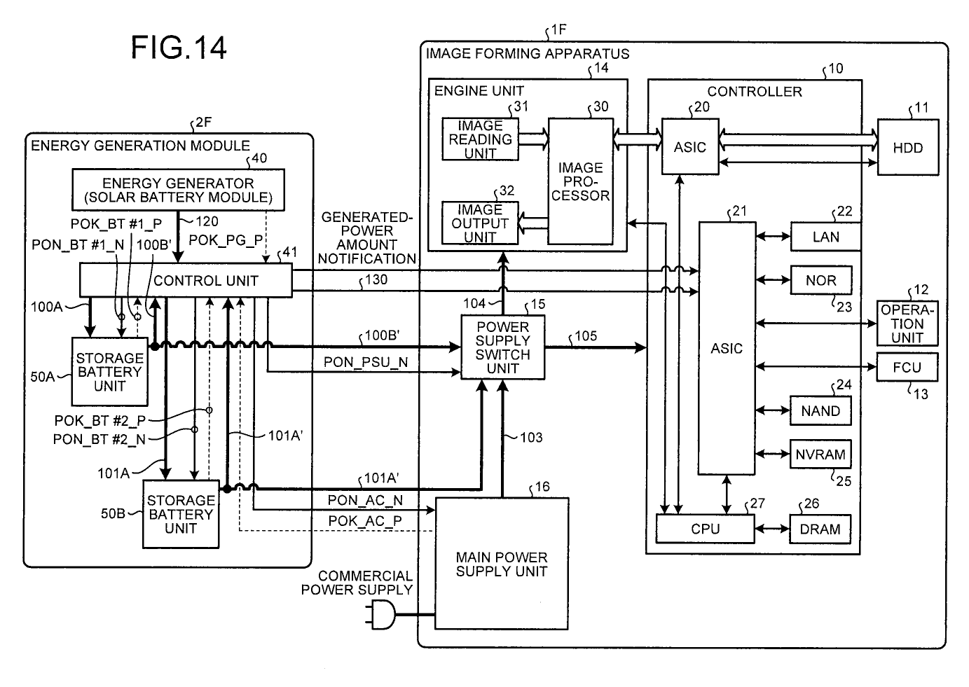

A second modification of the second embodiment will be described below. FIG. 14 shows an exemplary configuration of an image forming apparatus 1F and an energy generation module 2F of the second modification of the second embodiment. The components in FIG. 14 that are common to both FIG. 5 and FIG. 14 are denoted by the same reference numbers and detailed descriptions thereof are omitted. FIG. 14 shows the configuration that follows on from the previously described configuration in FIG. 5. However, the second modification of the second embodiment is applicable to the configurations of the first embodiment, the modifications of the first embodiment, the second embodiment, and the first modification of the second embodiment.

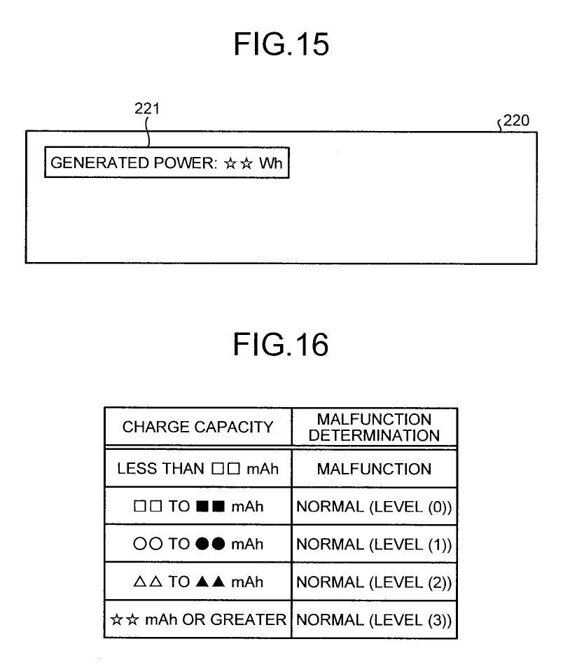

In the second modification of the second embodiment, in the energy generation module 2F, the control unit 41 measures the amount of generated power supplied from the energy generator 40 via the path 120 and transmits the value of the amount of measured generated power to the ASIC 21 in the controller 10 of the image forming apparatus 1F. The CPU 27 generates a display control signal for displaying the value of the amount of the generated power received by the ASIC 21. The generated display control signal is supplied to the operation unit 12 via the ASIC 21. In accordance with the supplied display control signal, the operation unit 12 displays a screen 220 indicating a generated power value 221 shown in FIG. 15 on the display unit of the operation unit 12.

As described above, in the second modification of the second embodiment, because the value of the amount of power generated by the energy generator 40 is displayed on the operation unit 12, the user can tell how much power the energy generator 40 is generating.

### Third Embodiment

A third embodiment of the present invention will be described here. In the third embodiment, for example, the image forming apparatus 1D and the energy generation module 2D shown in FIG. 8 can be used. In addition, the third embodiment is applicable to the first embodiment, each of the modifications of the first embodiment, the second embodiment, and each of the modifications of the second embodiment.

The third embodiment relates to processing performed when the storage battery units 50A and 50B malfunction. In the processing, it is determined whether the storage battery units 50A and 50B have malfunctioned on the basis of their charge capacities and, when it is determined that the storage battery units 50A and 50B have malfunctioned, the power generated by the energy generator 40 is used as the power supply to the image forming apparatus 1.

The third embodiment is similar to the second embodiment in that the storage battery units 50A and 50B respectively transmit, to the control unit 41, charge capacity notification signals indicating the charge capacities. The storage battery units 50A and 50B measure the output voltages of their storage batteries and, on the basis of the result of the measurement, the amount of charge in the storage battery units 50A and 50B is obtained as charge capacities. The control unit 41 transmits, to the ASIC 21 in the controller 10, charge capacity notification signals indicating the charge capacities of the storage battery units 50A and 50B on the basis of the signals that indicate the charge capacities and that are transmitted from the storage battery units 50A and 50B.

In contrast, a malfunction determination table for determining, on the basis of their charge capacities, whether the storage battery units 50A and 50B have malfunctioned is stored in the NAND flash memory 24 in the controller 10. FIG. 16 shows an exemplary configuration of the malfunction determination table. The charge capacity range and the information indicating whether a malfunction has occurred are associated with each other with respect to both of the storage battery units 50A and 50B and are stored in the malfunction determination table. In the example in FIG. 16, furthermore, the charge capacity range and the charge level are associated with each other and stored in the malfunction determination table. In this example, the charge levels from the level (0) to level (3) are associated with the charge capacity ranges at four levels. In other words, when the charge capacity is less than a threshold, it is determined that the storage battery unit has malfunctioned. When the charge capacity is equal to the threshold or greater, the charge level is determined according to the charge capacity.

In the malfunction determination table shown in FIG. 16, the charge capacity ranges and the information indicating whether a malfunction has occurred are associated with each other and, furthermore, four stages of charge level are associated with the charge capacity ranges equal to or greater than the threshold and stored. This is not limited to this example. As described using, for example, FIG. 9, in the malfunction determination table, the information indicating whether has malfunction occurred and display information for displaying the charge levels can be associated with the charge capacity ranges.

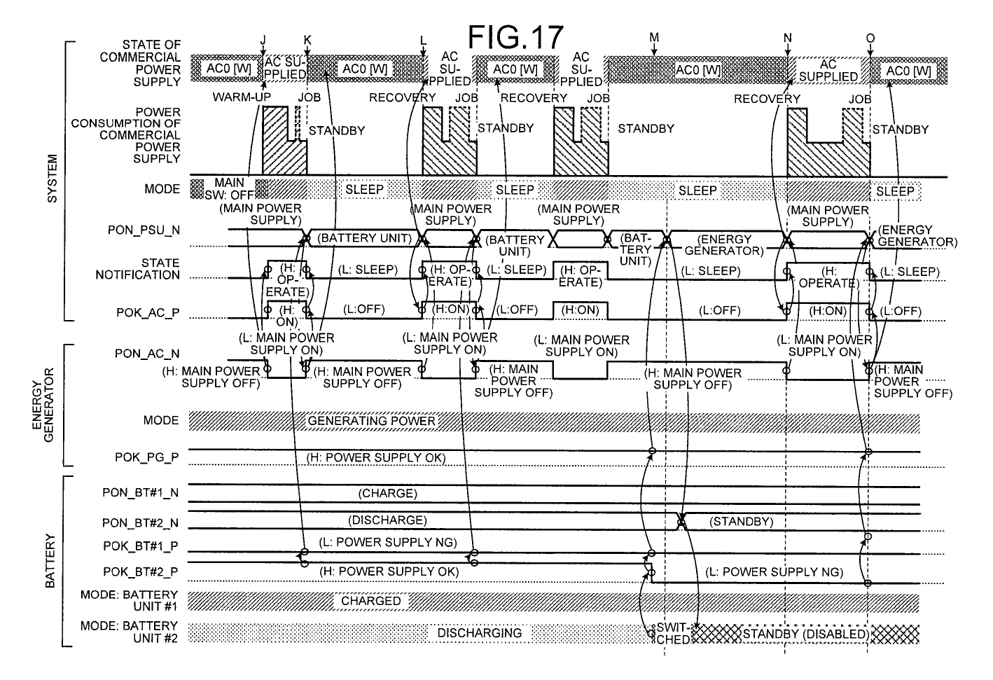

Operations according to the third embodiment will be described using FIG. 17. FIG. 17 is a sequence chart indicating the transition of the state of each unit. In the third embodiment, the signal PON_PSU_N for selecting a power supply source covers a first state in which the main power supply unit 16 is selected as a power supply source, a second state in which the storage battery units 50A and 50B are selected as a power supply source, and a third state in which the energy generator 40 is selected as a power supply source.

In the example in FIG. 17, when the signal POK_AC_P is with the L level and the main switch is turned off until the time point J, the signal POK_PG_P is at the H level, which indicates that the energy generator 40 can supply power. Furthermore, originally, the signal POK_BT#1_P is at the L level and the signal POK_BT#2_P is at the H level, which indicates that the storage battery unit 50A cannot supply power and the storage battery unit 50B can supply power. The storage battery unit 50A is controlled by the control unit 41 so that the storage battery unit 50A can be charged using power generated by the energy generator 40. The discharge output of the storage battery unit 50B is supplied to the control unit 41.

When the main switch is turned on at the time point H, the control unit 41 switches the signal PON_AC_N to the L level to turn on the main power supply unit 16 so that the power supply from the main power supply unit 16 to the power supply switch unit 15 is started. In the initial state, the signal PON_PSU_N is at the first state in which the main power supply unit 16 is selected as a power supply source and thus power from the main power supply unit 16 is selected. Thus, power can be supplied from the main power supply unit 16 to the engine unit 14 and the controller 10 via the power supply switch unit 15. The image forming apparatus 1 enters the standby state after a warm-up operation, and a job occurs due to a user operation, etc.

If no job occurs until a predetermined time elapses after the job is completed, the operation mode of the image forming apparatus 1 is shifted from normal mode to sleep mode. At the time point K at which the operation mode has shifted to the sleep mode, the signal POK_BT#1_P and the signal POK_BT#2_P are at the L level and the H level, respectively, which indicates that the storage battery unit 50B can supply power. Thus, the control unit 41 causes the signal PON_PSU_N to be in the second state in which the storage battery units 50A and 50B are selected as a power supply source, controls the power supply switch unit 15 so that it selects the power 102 from the control unit 41 as a power supply source, and supplies the output of the storage battery unit 50B as the power 102 to the power supply switch unit 15. The control unit 41 causes the signal PON_AC_N to be at the H level to turn off the main power supply unit 16 so that the operation mode is shifted to the sleep mode.

When the operation mode recovers from the sleep mode (time point L), the control unit 41 causes the signal PON-AC_N to be at the L level to turn on the main power supply unit 16 and causes the signal PON-PSU_N to be in the first state to control the power supply switch unit 15 such that it selects the power 103 from the main power supply unit 16. Accordingly, the image forming apparatus 1 recovers to normal mode and waits for a job.

Processing is described that is performed when, in the sleep mode, it is determined that the storage battery unit 50B that is supplying power malfunctions. The CPU 27 refers to the malfunction determination table on the basis of the charge capacity notification signals, which are transmitted from the control unit 41 and received by the ASIC 21, and determines whether a malfunction has occurred. In the example in FIG. 17, at the time point M, the CPU 27 detects that the charge capacity of the storage battery unit 50B is less than the threshold on the basis of the charge capacity notification signals and thus determines that the storage battery unit 50B has malfunctioned. The CPU 27 notifies, via the ASIC 21, the control unit 41 that the storage battery unit 50B has malfunctioned.

According to the notification that the storage battery unit 50B has malfunctioned, the control unit 41 changes the signal POK_BT#2_P from the H level to the L level, which indicates that the storage battery unit 50B cannot supply power. In contrast, at the time point M, the signal POK_BT#1_P is at the L level, so the storage battery unit 50A cannot supply power, and the signal POK_PG_P is at the H level, so the energy generator 40 can supply power.

The control unit 41 changes the signal PON_PSU_N to the third state in which the energy generator 40 is selected as a power supply source, and the control unit 41 controls the power supply switch unit 15 such that it selects the power 102 from the control unit 41. In addition, the control unit 41 supplies the output of the energy generator 40 as the power 102 to the power supply switch unit 15. The control unit 41 then changes the signal PON_BT#2_N to the state indicating “Standby (Disabled)”.

When recovering the operation state from the sleep mode (time point N), the control unit 41 causes the signal PON_AC_N to be at the L level to turn on the main power supply unit 16, changes the signal PON_PSU_N to the first state, and controls the power supply switch unit 15 such that it selects the power 103 from the main power supply unit 16. Accordingly, the image forming apparatus 1 recovers to normal mode and waits for a job.

When shifting the operation state to the sleep mode (time point O), the signal POK_BT#1_P and the signal POK_BT#2_P are at the L level, so the storage battery units 50A and 50B cannot supply power, and the signal POK_PG_P is at the H level, so the energy generator 40 can supply power. The control unit 41 thus switches the signal PON_PSU_N to the third state, controls the power supply switch unit 15 such that it selects the power 102 from the control unit 41, and switches the signal PON_AC_N to the H level to turn off the main power supply unit 16. Accordingly, the operation mode shifts to the sleep mode.

As described above, according to the third embodiment, even if the storage battery units 50A and 50B cannot supply power, the power can be supplied to the image forming apparatus 1 without supplying power from the commercial power supply.

According to the embodiments, an effect is achieved in which termination can be prevented of the power supply by the secondary battery in a power-saving control mode.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A power supply device, comprising:
a power generation unit;
a plurality of storage batteries configured to be charged with power output from the power generation unit;
a monitoring unit configured to monitor a state of each storage battery and the power output from the power generation unit; and
a control unit configured to select one of the storage batteries to supply power to a target device on the basis of a monitoring result by the monitoring unit when the target device is in a power saving mode, the control unit being configured to control charging of each storage battery.

2. The power supply device according to claim 1, wherein
the monitoring unit monitors whether each storage battery is in a state that allows for discharging, a state that requires charging, or a disabled state, and
the control unit controls the storage battery that is in the disabled state so that the storage battery is not charged and does not discharge, according to the monitoring result by the monitoring unit.

3. The power supply device according to claim 2, wherein
when any one of the storage batteries is in the disabled state as the monitoring result by the monitoring unit, the control unit controls the power generation unit so that the power output from the power generation unit is supplied to the target device.

4. The power supply device according to claim 1, wherein
on the basis of the monitoring result by the monitoring unit, the control unit outputs, to the target device, storage battery information indicating at least one of a charge capacity and a life of each storage battery.

5. The power supply device according to claim 1, wherein
on the basis of the monitoring result by the monitoring unit, the control unit outputs, to the target device, power generation information indicating an amount of power generated by the power generation unit.

6. A method of controlling a power supply device, comprising:
monitoring, by a monitoring unit, states of a plurality of storage batteries and power output from a power generation unit;
controlling, by a control unit, charging of each storage battery; and
selecting, by the control unit, one of the storage batteries to supply power to a target device on the basis of a result at the monitoring when the target device is in a power saving mode.

7. An image forming apparatus comprising:
the power supply device according to claim 1;
an image forming unit that is the target device;
a main power supply unit configured to supply power to the image forming unit when the image forming unit is in at least a normal mode; and
a power supply switch unit configured to switch a source of power supply to the image forming unit to the main power supply unit when the image forming unit is in the normal mode, and switch the source of power supply to at least one of the power generation unit and the storage batteries when the image forming unit is in the power saving mode.

8. The image forming apparatus according to claim 7, wherein
the power supply device is configured to be detachable, and
the image forming apparatus further comprises
a detector configured to detect whether the power supply device is connected to the image forming apparatus; and
an image forming apparatus controller configured to control the power supply switch unit so that the power supply switch unit switches the source of power supply to the main power supply unit when the detector detects that the power supply device is not connected to the image forming apparatus.

9. The image forming apparatus according to claim 7, wherein
on the basis of the monitoring result by the monitoring unit, the control unit outputs at least one of information indicating at least one of a charge capacity and a life of each storage battery and information indicating an amount of power generated by the power generation unit, and
the image forming apparatus further comprises a display unit configured to gives a display on the basis of the information output by the control unit.
